(19) United States
(12) Patent Application Publication
(10) Pub. No.: US 2008/0297648 A1
(43) Pub. Date: Dec. 4, 2008

(54) FOCUS DETECTION APPARATUS

(76) Inventors: Satoko Furuki, Utsunomiya-shi (JP); Akikazu Yachi, Hachioji-shi (JP); Toru Matsuzawa, Kunitachi-shi (JP); Nobuyuki Watanabe, Yokohama-shi (JP)

Correspondence Address: STRAUB & POKOTYLO, 788 Shrewsbury Avenue, TINTON FALLS, NJ, 07724, US

(21) Appl. No.: 12/120,513

(22) Filed: May 14, 2008

Related U.S. Application Data
(63) Continuation of application No. PCT/JP2006/322265, filed on Nov. 8, 2006.

(30) Foreign Application Priority Data
Nov. 15, 2005 (JP) 2005-330460

(51) Int. Cl. H04N 5/225

(52) U.S. Cl. 348/345; 348/E05.024

(57) ABSTRACT

A blurring parameter operating section calculates a blurring parameter corresponding to a distance from an optical system to a subject, based on two luminance information items which have different blurring degrees and are acquired by changing an arrangement setting of the optical system. A distance estimating section estimates distance information corresponding to the distance from the optical system to the subject, based on the blurring parameter. A focus detection section acquires luminance information after changing arrangement setting of the optical system based on the distance information, acquires luminance information items having different blurring degrees by further changing arrangement setting of the optical system, calculates an evaluation value indicating a degree of focus from each of the luminance information items having the different blurring degrees, and determines the focal position based on the evaluation value.

### CROSS REFERENCE TO RELATED APPLICATIONS

This is a Continuation Application of PCT Application No. PCT/JP2006/322265, filed Nov. 8, 2006, which was published under PCT Article 21(2) in Japanese.

This application is based upon and claims the benefit of priority from prior Japanese Patent Application No. 2005-330460, filed Nov. 15, 2005, the entire contents of which are incorporated herein by reference.

### BACKGROUND OF THE INVENTION

1. Field of the Invention

The present invention relates to a focus detection apparatus which specifies a focus position by using a light beam that has passed an optical system which forms an image of light from a subject on a predetermined position.

2. Description of the Related Art

The most general method as methods of detecting a focus by using an image acquisition device include technique called hill climbing method or contrast method. The focus detection method is widely used for electronic image acquisition apparatuses such as digital cameras.

In the focus detection method, a plurality of images are acquired while a focus lens is driven in the optical axis direction, and an evaluation value of blurring is calculated for the acquired images. A contrast or a sum of high-frequency components of the image is used as the evaluation value. The greater value the evaluation value has, the more properly the focus is attained.

The focus detection method using above evaluation value is explained in more detail. The focus lens is driven with a minute distance in the near-point or far-point direction from the current position (hereinafter referred to as the “start point”) of the focus lens. For example, first, the focus lens is driven in the far-point direction. If the evaluation value calculated during the driving is reduced in comparison with the evaluation value calculated at the start point, it means that the peak of the evaluation value exists in the direction (near-point direction) opposite to the driving direction. Therefore, in such a case, the focus lens is driven in the opposite direction. In the case of having such relationship, when the focus lens is driven first in the near-point direction from the start point, the evaluation value in the first driven direction increases. Therefore, in such a case, the peak of the evaluation value exists in the driving direction, and thus the focus lens is kept driven in the same direction.

While the focus lens is driven, images are acquired at constant time intervals, and the evaluation value in the acquired images is calculated. While the evaluation value increases, driving of the lens and calculation of the evaluation value are continued. Then, when the evaluation value starts to decrease, it is determined that the focus lens has passed the in-focus position, and driving of the lens is stopped. Then, a quadric approximate curve of the evaluation value is calculated by using three evaluation values, that is, the maximum value of the calculated evaluation values, and evaluation values calculated in the focus lens positions in both neighbors of the maximum value. Then, a focus lens position in which the evaluation value has the maximum value in the quadric approximate curve is determined. The lens is driven to the focus lens position, and thereby the focus detection is ended.

As described above, since focus information or distance information of a subject is estimated by using an estimated value of the focus position, the focus detection method is called “Depth From Focus (hereinafter abbreviated to “DFF”) method”. Further, the method is also called “hill climbing method”, since control is performed to enhance the evaluation value and the peak of the evaluation value is estimated. As described above, the in-focus position coincides with the position of the focus lens where the evaluation value calculated by the “hill climbing method” is at the maximum.

In comparison with this, for example, U.S. Pat. No. 4,965,840 discloses a focus detection method called “Depth From Defocus (hereinafter abbreviated to “DFD” method). In this method, luminance information is obtained in two positions having different optical configurations focal length or aperture size. Then, a plurality of images having different blurring degrees are computed, and thereby blurring parameter is calculated and the focus is determined. The blurring parameter is a representative value indicating the blurring state of the luminance information, and indicates a value correlated with the variance of the point spread function (PSF) of the optical system. PSF is a function indicating how the light beam spreads when an ideal point image passes an optical system.

The outline of steps of the DFD method disclosed in the above U.S. Pat. No. 4,965,840 is explained below. The details of computing performed in these steps are disclosed in the above USP document, and not explained herein.

In the DFD method, at least two luminance information items for focus determination are obtained from the same subject, the same region, and the same viewing direction, by changing at least one of image acquisition parameters which influence the blurring state of acquired images. The image acquisition parameters include the focus lens position, the aperture, and the focal length, etc. In this explanation, only the case is explained in which only the position of the focus lens is changed.

In this DFD method, the focus lens is moved to a predetermined first position and a second position, to change the optical path between the image acquisition section being a luminance information obtaining section and the subject, that is, to change the blurring state of the image formed on the image plane of the image acquisition section. Further, first luminance information is obtained in the first position, and second luminance information is obtained in the second position. These obtained luminance information items are subjected to low-pass filter to remove electric noises, image magnification correction to adjust the different magnifications between the first and second images, and normalization of luminance distribution. If necessary, a region of interest for focus evaluation is selected in the obtained luminance information. Selection is performed for one of the luminance information, and a corresponding region is selected for the other luminance information. Then, a difference between the first luminance information and the second luminance information is calculated from two normalization processing results in the regions for which focus evaluation is to be performed. Further, the second-order differential of each of the first luminance information and the second luminance information is calculated, and a mean value of them is calculated. Then, the difference between the first luminance information and the second luminance information is divided by the mean value of the second order differentials of the luminance information items, and thereby a blurring parameter correlated with PSF variance corresponding to the first or second luminance information is calculated.

Based on the calculated blurring parameter of PSF, the subject distance is obtained based on the relational expression between the PSF variance and the subject distance disclosed in U.S. Pat. No. 4,965,840. The relationship between the blurring parameter and the subject distance differs according to the structure and the state (zoom, aperture) of the lens. Further, the relationship between a certain subject distance and the focus lens position in which focus is attained for the subject distance, that is, the in-focus lens position is provided in advance by data of the lens system. Therefore, the relationship between the blurring parameter and the in-focus lens position to be controlled is determined by individual relational expressions or operational tables according to the lens system and the configuration of the lens.

### BRIEF SUMMARY OF THE INVENTION

According to an aspect of the present invention, there is provided a focus detection apparatus which determines a focal position by using light beam that is passed an optical system which forms an image of light from a subject in a predetermined position, comprising:

a luminance information acquiring section configured to acquire luminance information of the image formed by the optical system;

a blurring parameter operating section configured to calculate a blurring parameter corresponding to a distance from the optical system to the subject, based on two luminance information items which have different blurring degrees and are acquired by the luminance information acquiring section;

a distance estimating section configured to estimate distance information corresponding to the distance from the optical system to the subject, based on the blurring parameter calculated by using the blurring parameter operating section; and

a focus detection section configured to acquire luminance information by using the luminance information acquiring section after changing arrangement setting of one of the optical system and the luminance information acquiring section based on the distance information estimated by the distance estimating section, to acquire luminance information items having different blurring degrees by the luminance information acquiring section by further changing arrangement setting of the one of the optical system and the luminance information acquiring section, to calculate an evaluation value indicating a degree of focus from each of the luminance information items having the different blurring degrees, and to determine the focal position based on the evaluation value.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram illustrating a structure of a compact camera to which a focus detection apparatus according to a first embodiment of the present invention is applied;

FIG. 2 is a block diagram of the focus detection apparatus according to the first embodiment;

FIG. 3 is a flowchart for explaining processing of the focus detection apparatus according to the first embodiment;

FIG. 4 is a diagram illustrating relationship between the blurring parameter and the in-focus lens position;

FIG. 5 is a diagram illustrating relationship between the focus evaluation value and the lens position for explaining a hill climbing method, and the initial position based on an estimation result of DFD;

FIG. 6 is a diagram illustrating a structure of a single-lens reflex camera to which a focus detection apparatus according to a modification of the first embodiment of the present invention is applied;

FIG. 7 is a block diagram of a focus detection apparatus according to a second embodiment of the present invention;

FIG. 8 is a flowchart for explaining processing of the focus detection apparatus according to the second embodiment;

FIG. 9 is a diagram illustrating an example of a distance image;

FIG. 10 is a diagram illustrating an example of a mask used for mask processing in a DFF region extraction section;

FIG. 11 is a diagram illustrating another example of the mask used for mask processing in the DFF region extraction section;

FIG. 12 is a block diagram of a focus detection apparatus according to a second modification of the second embodiment;

FIG. 13 is a diagram illustrating an example of an operation result of a second-order differential operation section;

FIG. 14 is a flowchart for explaining processing of the focus detection apparatus according to the second modification of the second embodiment;

FIG. 15 is a block diagram of a focus detection apparatus according to a third modification of the second embodiment;

FIG. 16 is a block diagram of a focus detection apparatus according to a third embodiment of the present invention; and

FIG. 17 is a diagram illustrating a structure of a compact camera to which a focus detection apparatus according to a fourth embodiment of the present invention is applied.

### DETAILED DESCRIPTION OF THE INVENTION

A best mode for carrying out the present invention will be described below with reference to drawings.

### First Embodiment

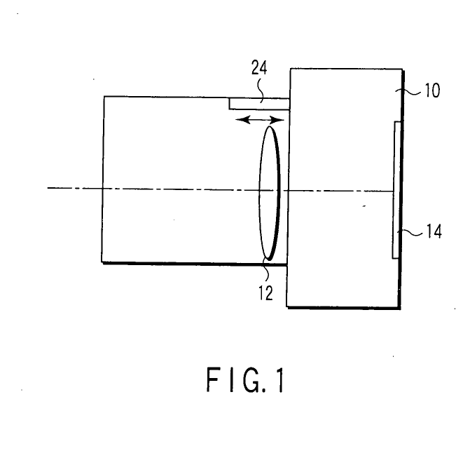

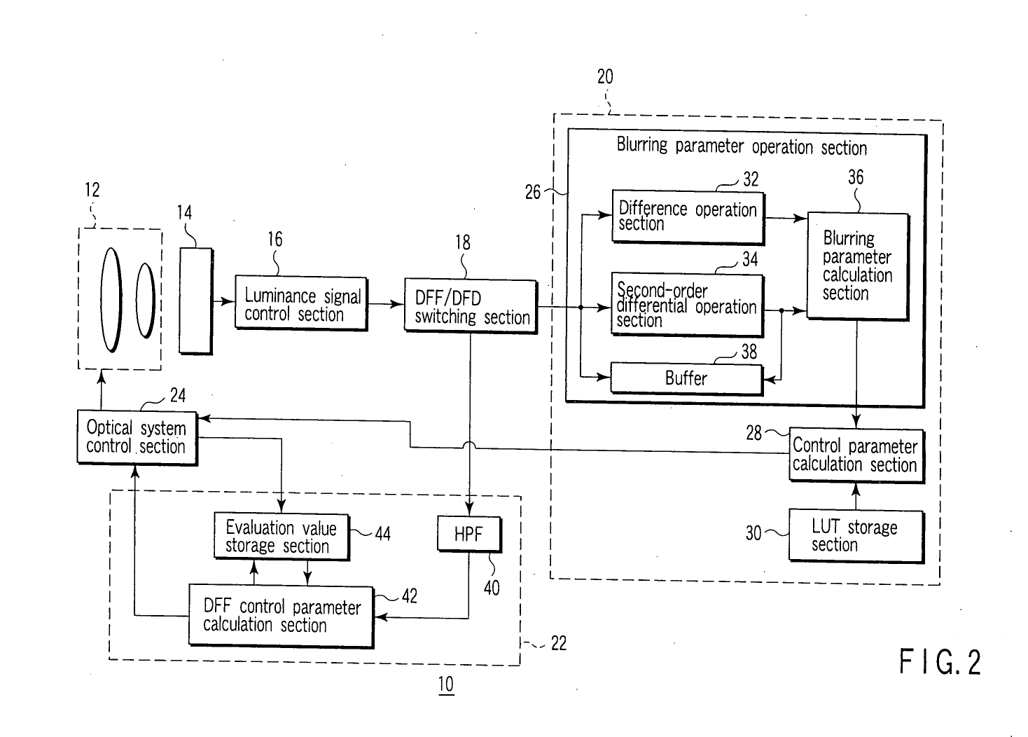

A focus detection apparatus according to the first embodiment is applied to a compact camera 10 as illustrated in FIG. 1. As illustrated in FIG. 2, the focus detection apparatus comprises an optical system 12, an image acquisition device 14 and a luminance signal control section 16 which function as a luminance information acquiring section, a DFF/DFD switching section 18, a distance estimating section 20, a hill climbing operation section 22, and an optical system control section 24.

The optical system 12 is formed of a plurality of lenses (taking lenses) aimed at acquiring images, and some of the lenses are configured to be driven in the optical axis direction to adjust the focus. The group of the lenses is called a focus lens. An image of a subject formed by the optical system 12 is converted into an electric signal by an optoelectronic transducer of the image acquisition device 14. The converted electric signal is converted into a digital signal by the luminance signal control section 16. The converted digital signal is called “luminance information”. The luminance information is input to the distance estimating section 20 and the hill climbing operation section 22. In the first embodiment, after the distance estimating section 20 estimates a subject distance which indicates a distance from the optical system 12 to the subject which is the object of image acquisition, the hill climbing operation section 22 which functions as a focus detection section performs processing to obtain a focusing result with higher accuracy. The hill climbing operation section 22 and the distance estimating section 20 are switched by the DFF/DFD switching section 18. Further, the optical system control section 24 functions as an arrangement control section for controlling the optical system 12 to a desired position, and is formed of an actuator and a drive circuit to drive the actuator, although not shown. For example, when the focus lens position obtained by the hill climbing operation section 22 is input to the optical system control section 24, the drive circuit generates a signal to be provided to the actuator to dispose the focus lens of the optical system 12 to the lens position, inputs the signal to the actuator, and thereby disposes the focus lens to the desired position.

Operation control of the above sections is performed by a controller (not shown) which controls the compact camera 10.

The distance estimating section 20 estimates the subject distance by DFD method. The distance estimating section 20 is formed of a blurring parameter operation section 26, a control parameter calculation section 28, and an LUT storage section 30.

The blurring parameter operation section 26 includes a difference operation section 32, a second-order differential operation section 34, a blurring parameter calculation section 36, and a buffer 38. The difference operation section 32 calculates an image difference necessary for calculating the blurring parameter. The second-order operation section 34 calculates second-order differentials of the image, and calculates a mean value of second-order differential results obtained from two luminance information items having different blurring degrees. The blurring parameter calculation section 36 calculates the blurring parameter by dividing the image difference calculated by the difference operation section 32 by the mean value of the second-order differentials calculated by the second-order differential operation section 34. The buffer 38 stores luminance information of the first image and a result of second-order differential thereof, since a plurality of luminance information items are obtained at different times by arranging the focus lens in different positions.

Further, the LUT storage section 30 stores relationship between the blurring parameter and the in-focus lens position in the form of a lookup table (LUT), as the relationship between the blurring parameter and the in-focus lens position. The position of the optical system 12 is determined according to the in-focus lens position.

The control parameter calculation section 28 determines the in-focus lens position corresponding to the blurring parameter calculated by the blurring parameter calculation section 36, with reference to the LUT of the LUT storage section 30.

On the other hand, the hill climbing operation section 22 includes a high-pass filter (HPF) 40, a DFF control parameter calculation section 42, and an evaluation value storage section 44. The HPF 40 extracts high-frequency components of luminance information. The DFF control parameter calculation section 42 adds results of the HPF 40, and calculates an evaluation value h(t). The evaluation value storage section 44 stores the lens position when the luminance information is acquired and the evaluation value calculated by the DFF control parameter calculation section 42.

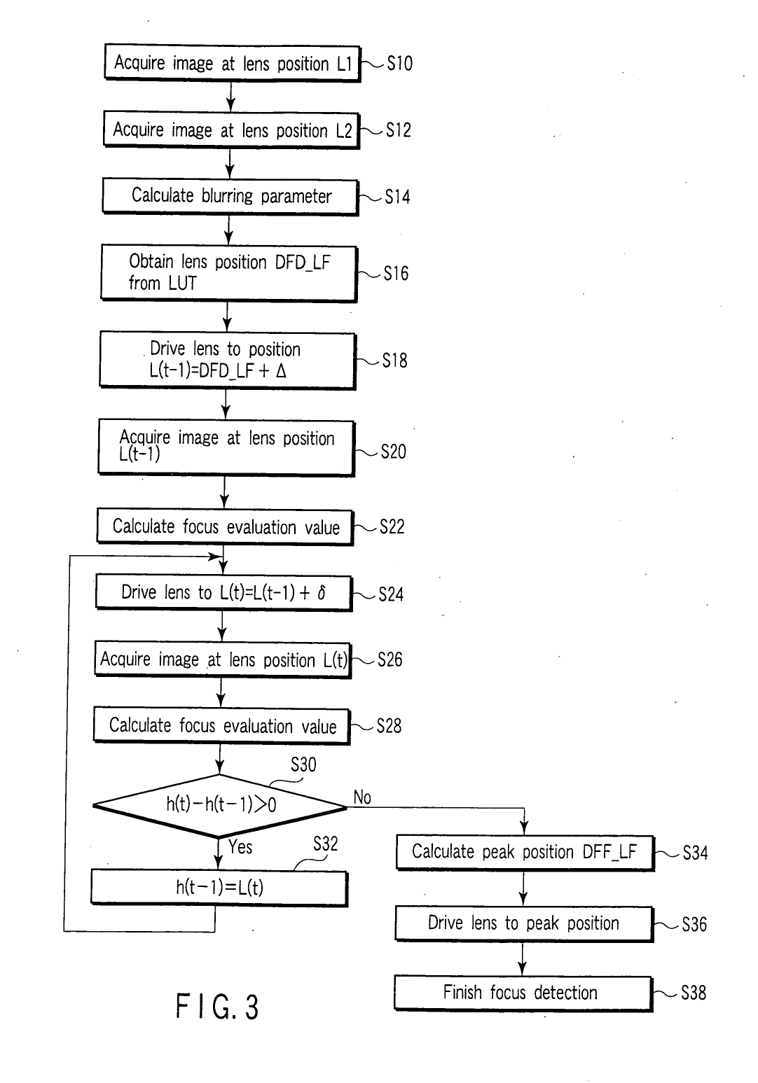

Processing performed by the focus detection apparatus according to the first embodiment is explained in detail with reference to the flowchart of FIG. 3.

Specifically, first, in accordance with control by the controller (not shown), the focus lens of the optical system 12 is driven to a predetermined first lens position L1 by the optical system control section 24, and the image acquisition device 14 and the luminance signal control section 16 acquire luminance information of a first image of the subject (Step S10). The acquired first luminance information is supplied by the DFF/DFD switching section 18 to the distance estimating section 20 in accordance with control of the controller, and stored in the buffer 38 in the blurring parameter operation section 26.

Thereafter, in accordance with control by the controller, the focus lens of the optical system 12 is driven to a predetermined second lens position L2 by the optical system control section 24, and the image acquisition device 14 and the luminance signal control section 16 acquire luminance information of a second image of the subject (Step S12). The acquired second luminance information is supplied by the DFF/DFD switching section 18 to the distance estimating section 20, in accordance with control by the controller.

When acquisition of the second luminance information is finished, the distance estimating section 20 calculates a blurring parameter (Step S14). Specifically, in the blurring parameter operation section 26, the difference operation section 32 reads the first luminance information from the buffer 38, and calculates a difference between the first luminance information and the second luminance information supplied from the DFF/DFD switching section 18. Further, the second-order differential operation section 34 calculates the second-order differential of the second luminance information supplied from the DFF/DFD switching section 18, and then reads the first luminance information from the buffer 38 and calculates the second-order differential thereof. Then, the second-order differential operation section 34 calculates a mean value of the calculated first and second second-order differentials. When the difference and the mean value of the second-order differentials are obtained, the blurring parameter calculation section 36 obtains a blurring parameter by dividing the output of the difference operation section 32 with the output of the second-order differential operation section 34.

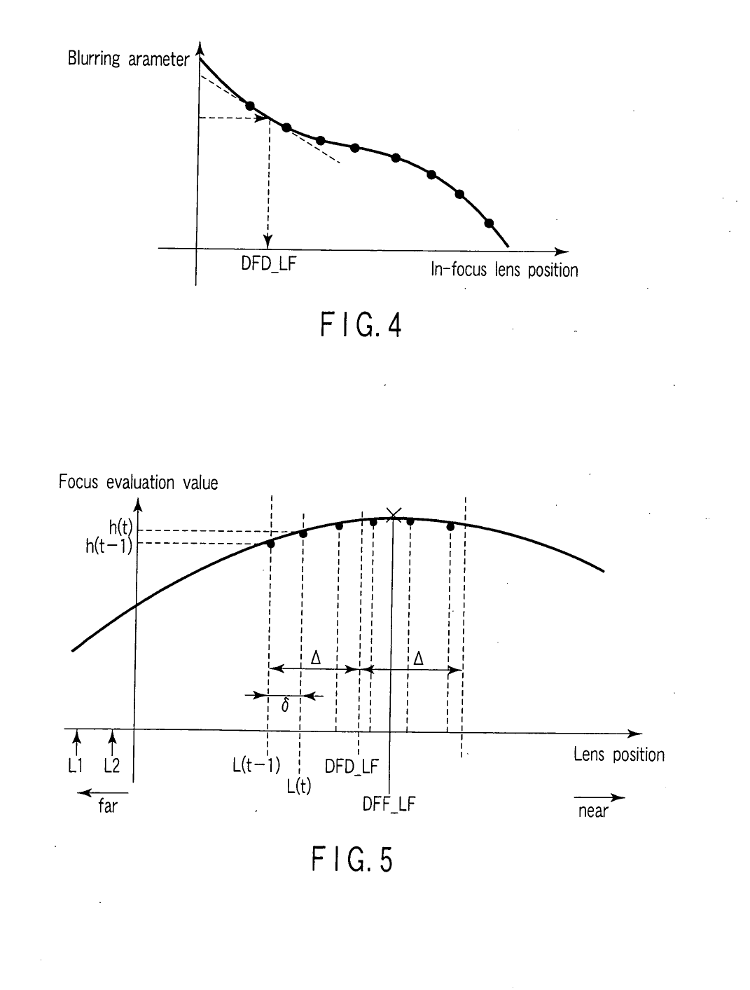

The blurring parameter has linear relation to the reciprocal of the subject distance, and the subject distance and the in-focus lens position has a relationship of one-to-one correspondence. Therefore, the relationship between the blurring parameter and the in-focus lens position also has a one-to-one correspondence as illustrated in FIG. 4. The relationship is stored as a table (LUT) in the LUT storage section 30. The control parameter calculation section 28 calculates a subject distance corresponding to the blurring parameter. The distance information corresponding to the value of the subject distance is indicated by the position of the focus lens. Thus, the in-focus lens position DFD_LF corresponding to the blurring parameter obtained by the blurring parameter operation section 26 can be determined by linear approximation with reference to the table stored in the LUT storage section 30 (Step S16).

An estimated error Δ of the in-focus lens position DFD_LF obtained in this step is larger than the tolerance, since the in-focus lens position for the subject minutely varies due to lens barrel mounting error of individual cameras. Therefore, the control parameter calculation section 28 sets a position DFD_LF+Δ, as the target lens position L(t−1), which is distant from the estimated in-focus lens position by the estimated error Δ beyond the lens barrel mounting error, and inputs it to the optical system control section 24. The optical system control section 24 drives the focus lens of the optical system 12 to the target lens position L(t−1) (Step S18).

As shown in FIG. 5, L(t−1) represents the position of the focus lens, which has been driven from the in-focus lens position “DFD_LF” by the estimated error Δ toward a far point. L(t) represents the position of the focus lens, which has been driven from L(t−1) by a predetermined amount δ toward a near point. The position DFD_LF+Δ is located between the lens position (L2), in which the luminance information of the second image acquired in the process of calculating the blurring parameter has been obtained, and the in-focus lens position DFD_LF, as illustrated in FIG. 5. By setting the lens to this position, the driving distance of the focus lens is reduced to the minimum.

After the focus lens is driven to the target lens position L(t−1), focus detection operation by the hill climbing operation section 22 using the hill climbing method is started by control by the controller.

Specifically, luminance information of the subject is acquired at the lens position L(t−1) by the image acquisition device 14 and the luminance signal control section 16 (Step S20). The acquired luminance information is supplied to the hill climbing operation section 22 by the DFF/DFD switching section 18, in accordance with control by the controller. The hill climbing operation section 22 extracts high-frequency components of the supplied luminance information by the HPF 40, adds a result obtained by the HPF 40 by the DFF control parameter calculation section 42, and calculates the evaluation value h(t−1) (Step S22). The calculated evaluation value is stored in the evaluation value storage section 44 together with the lens position, in which the luminance information is acquired, provided from the optical system control section 24.

Next, the DFF control parameter calculation section 42 drives the focus lens of the optical system 12 by the optical system control section 24 by a predetermined amount δ in the direction of the estimated in-focus lens position DFD_LF, on the basis of the lens position stored in the evaluation value storage section 44 (Step S24). Then, the image acquisition device 14 and the luminance signal control section 16 acquire luminance information of the subject at the driven lens position L(t) (Step S26), and the evaluation value is calculated again by the hill climbing operation section 22 as described above (Step S28). The calculated evaluation value is stored in the evaluation value storage section 44 together with the lens position provided from the optical system control section 24.

Then, it is determined whether the value of “h(t)−h(t−1)” is positive or not (Step S30). When the value of “h(t)−h(t−1)” is positive, the current lens position L(t) is changed to the previous lens position (t−1) (Step S32), and the above processing is repeated by returning to Step S24.

When it is determined in Step S30 that the value of “h(t)−h(t−1)” is not positive, the DFF control parameter calculation section 42 estimates the peak position DFF_LF (Step S34). In this step, the evaluation values and the lens positions stored in the evaluation value storage section 44 are subjected to approximation to quadric, and the lens position DFF_LF which serves as the peak of the curve is calculated. Then, the DFF control parameter calculation section 42 provides the calculated lens position DFF_LF to the optical system control section 24, and drive the focus lens of the optical system 12 to the position (Step S36). When the focus lens is moved to the lens position DFF_LF, focus detection is finished (Step S38).

Although the evaluation value of the hill climbing method is determined by addition of high-frequency components extracted by the HPF 40 in the first embodiment, variance may be determined from distribution of luminance, and a value in which variance increases as the more proper focus is attained may be determined.

Further, although it is explained in the embodiment that control of the actuator of the optical system control section 24 is only performed by an open-loop method, a feedback control may be performed by an encoder attached to the actuator.

### Modification of the First Embodiment

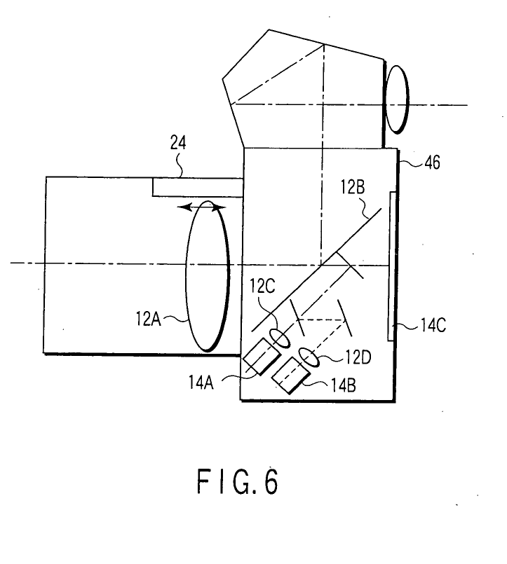

Although the first embodiment shows an example in which the focus detection apparatus is applied to a compact camera, the focus-detection apparatus of the first embodiment is also applicable to a single-lens reflex camera 46 as illustrated in FIG. 6 in the same manner.

Specifically, in the single-lens reflex camera 46, the optical system 12 is formed of a taking lens 12A, a reflex mirror 12B, and AF optical systems 12C and 12D to guide light beams to AF image acquisition devices 14A and 14B for focus detection. Further, the taking lens 12A includes a focus lens to adjust the focus. The image acquisition device 14 includes an image acquisition device 14C for acquiring an image and two AF image acquisition devices (14A and 14B), one of the AF image acquisition devices is disposed in an optically equal position as that of the image acquisition device 14C. In this modification, the AF image acquisition device 14A is disposed in the position. The optical system control section 24 is formed of an actuator and a drive circuit to drive the focus lens of the taking lens 12A.

When the focus detection apparatus of the first embodiment is applied to the single-lens reflex camera 46 as described above, the distance estimating section 20 can acquire two luminance information items by the AF image acquisition devices 14A and 14B at predetermined one lens position L. The two luminance information which is acquired at the lens position L corresponds to the two luminance information at the lens position L1 and L2. Then, the blurring parameter is calculated by using the two luminance information items simultaneously acquired (Step S14). Thereafter, the control parameter calculation section 28 estimates the in-focus lens position DFD_LF corresponding to the blurring parameter, with reference to the LUT storage section 30, in the same manner as the first embodiment (Step S16). Then, a position distant from the estimated in-focus lens position DFD_LF by the estimated error Δ beyond the lens barrel mounting error is set as the target lens position DFD_LF+Δ, and inputs the position to the optical system control section 24 (Step S18). The optical system control section 24 disposes the focus lens in the target lens position.

When control of the focus lens is finished, the hill climbing method is started thereafter. The hill climbing method is performed by using the luminance information acquired from the AF image acquisition device 14A located in the position equal to the image acquisition device 14C, among the two AF image acquisition devices (14A, 14B). Specifically, the evaluation value h(t) is calculated in the same manner as the first embodiment (Step S22), and the focus lens position DFF_LF which serves as the peak of the evaluation value is determined (Step S24 to S34). Then, the focus lens is controlled to be located in the lens position (Step S36), and focus detection is finished (Step S38).

### Second Embodiment

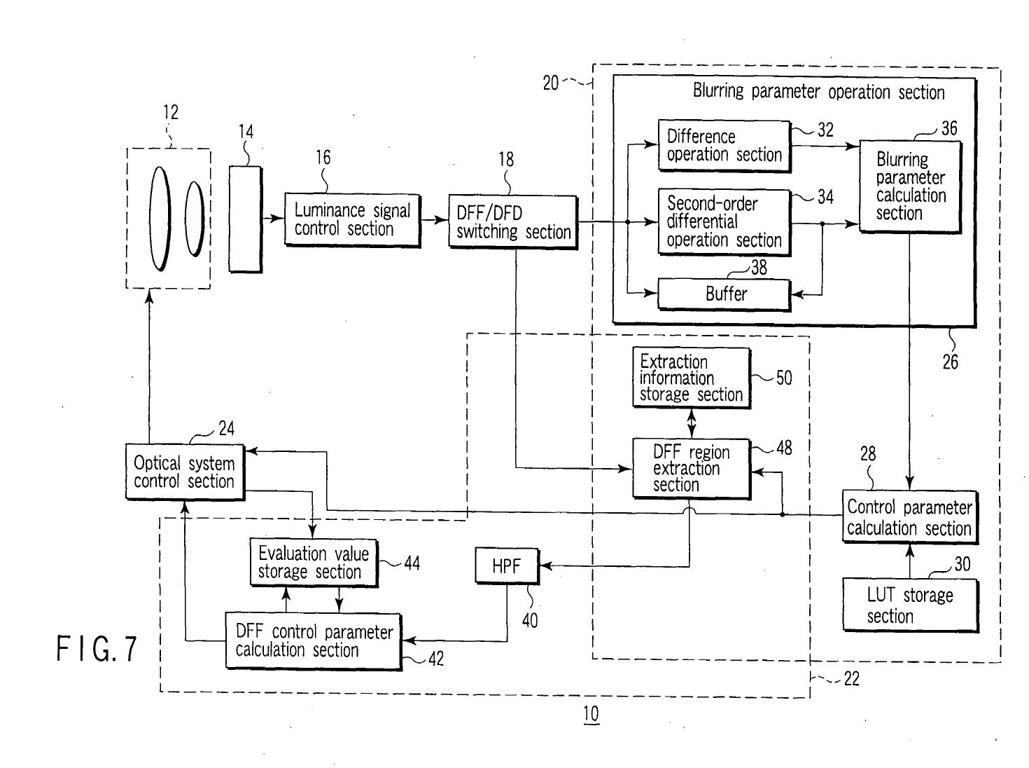

A focus detection apparatus according to the second embodiment is applied to a compact camera 10 as illustrated in FIG. 1. As illustrated in FIG. 7, the focus detection apparatus comprises an optical system 12, an image acquisition device 14 and a luminance signal control section 16 which function as a luminance information acquiring section, a DFF/DFD switching section 18, a distance estimating section 20, a hill climbing operation section 22, and an optical system control section 24, in the same manner as the first embodiment.

However, in the second embodiment, the focus detection apparatus has a structure also including a DFF region extraction section 48 and an extraction information storage section 50, which are used in both the distance estimating section 20 and the hill climbing operation section 22. The DFF region extraction section 48 determines the in-focus lens position of the subject which has the nearest distance. The extraction information storage section 50 selects a block in which the subject having the shortest distance exists, and stores the address of the selected block.

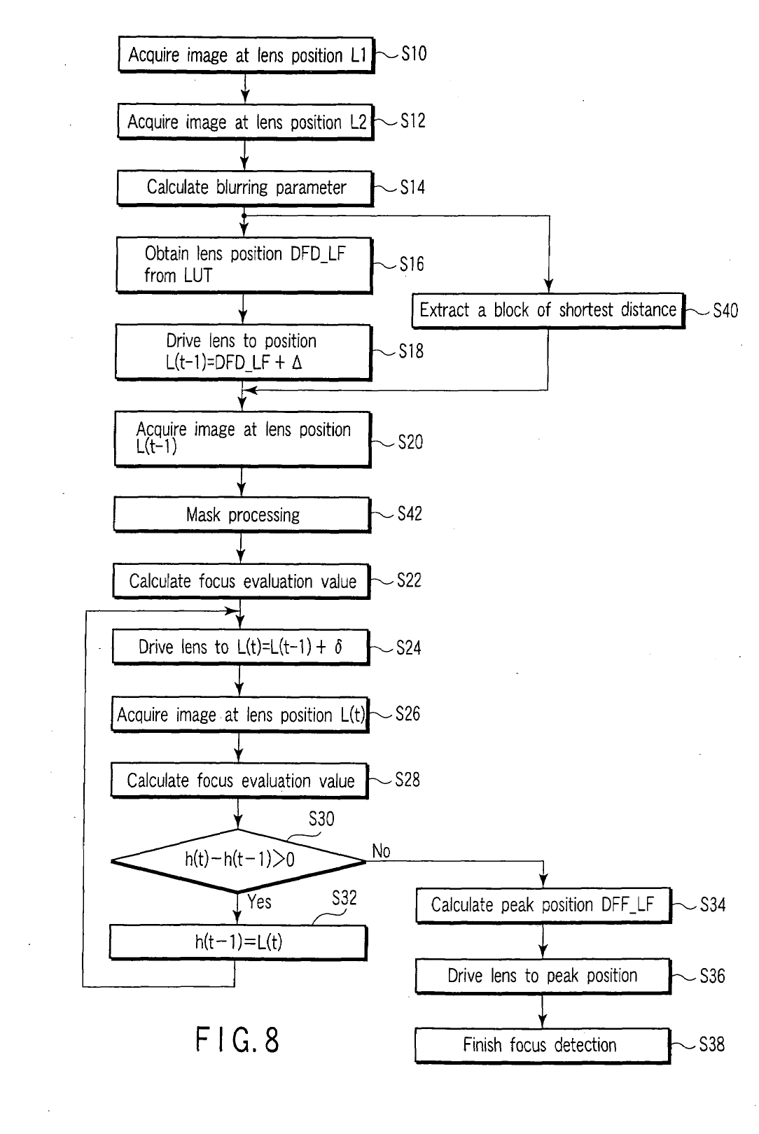

Processing performed by the focus detection apparatus according to the second embodiment is explained in detail with reference to the flowchart of FIG. 8.

Specifically, first, as explained in the first embodiment, the focus lens of the optical system 12 is driven to a predetermined first lens position L1, and luminance information of a first image of the subject is acquired and supplied to the blurring parameter operation section 26 of the distance estimating section 20 (Step S10). Thereafter, the focus lens of the optical system 12 is driven to a predetermined second lens position L2, luminance information of a second image of the subject is acquired and supplied to the blurring parameter operation section 26 of the distance estimating section 20 (Step S12).

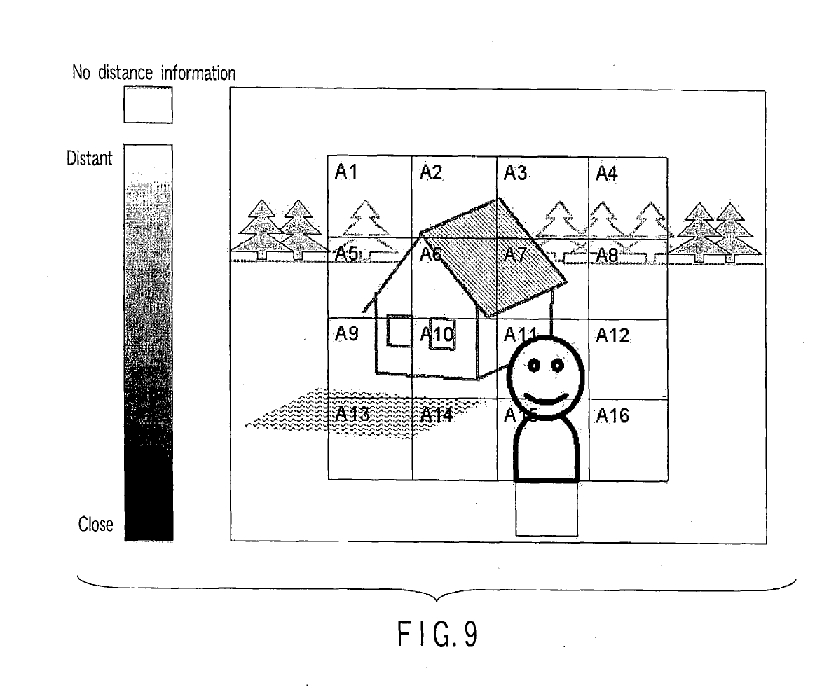

The blurring parameter operation section 26 calculates a blurring parameter by division of a difference between two images acquired at different focus lens positions by the mean value of the second-order differentials of the two images (Step S14). The blurring parameter has linear relation to the reciprocal of the subject distance, and the subject distance and the in-focus lens position has a relationship of one-to-one correspondence. Therefore, the relationship between the blurring parameter and the in-focus lens position also has a one-to-one correspondence. The relationship is stored as a table (LUT) in the LUT storage section 30. The control parameter calculation section 28 determines the in-focus lens position for the subject by linear interpolation, by using the calculated blurring parameter and the information of the LUT. The in-focus lens position is calculated pixel by pixel for an edge portion of the image of the subject formed on the image plane. The control parameter calculation section 28 further converts the value of the in-focus lens position into a value of the subject distance, and thereby obtains an image as illustrated in FIG. 9, which is called “distance image”. The distance image is supplied to the DFF region extraction section 48, and the in-focus lens position DFD_LF of the subject having the shortest distance (Step S16). Further, the DFF region extraction section 48 selects a block in which the subject exists, and causes the extraction information storage section 50 to store the address of the selected block(s) (A11 and A15 in the example of FIG. 9) (Step S40).

An estimated error Δ obtained in this step is larger than the tolerance, since the in-focus lens position for the subject minutely varies due to lens barrel mounting error of individual cameras. Therefore, the DFF region extraction section 48 sets a position which is distant from the estimated in-focus lens position by the estimated error Δ beyond the lens barrel mounting error as the target lens position DFD_LF+Δ, and inputs it to the optical system control section 24 (Step S18).

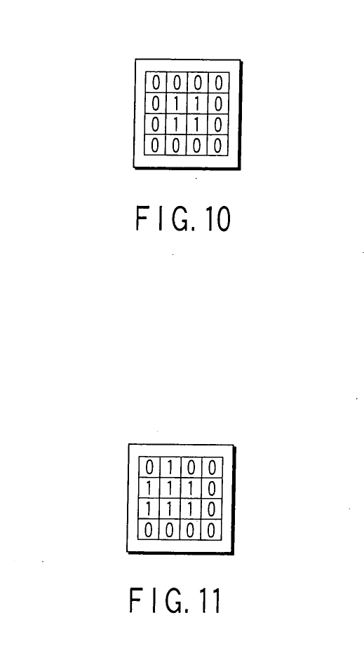

After the focus lens is driven to the target lens position DFD_LF+Δ by the optical system control section 24, the hill climbing method is started. Specifically, luminance information which has passed through the image acquisition device 14 and the luminance signal control section 16 is supplied to the DFF region extraction section 48 by the DFF/DFD switching section 18, which has been switched to the hill climbing operation section 22 by the controller (not shown) (Step S20). Since the extraction information storage section 50 stores in advance the address of the block in which the noted subject exists based on the result of DFD, the DFF region extraction section 48 extracts the luminance information in the block by mask processing (Step S42). Generally, masks as illustrated in FIGS. 10 and 11 are used as the mask used for the mask processing.

The HPF 40 extracts high-frequency components of the luminance information extracted by the DFF region extraction section 48. The DFF control parameter calculation section 42 adds results of the HPF 40 and calculates the evaluation value (Step S22). The calculated evaluation value is stored in the evaluation value storage section 44 together with the lens position, in which the luminance information is acquired, provided from the optical system control section 24.

Next, the focus lens of the optical system 12 is driven by a predetermined amount δ in the direction of the estimated in-focus lens position, on the basis of the current lens position stored in the evaluation value storage section 44 (Step S24). Then, luminance information is acquired (Step S26), and the evaluation value is calculated again (Step S28). The calculated evaluation value is stored in the evaluation value storage section 44 together with the lens position provided from the optical system control section 24. This processing is repeated when the value of “h(t)−h(t−1)” is positive (Step S30).

When the value of “h(t)−h(t−1)” is not positive (Step S30), the DFF control parameter calculation section 42 estimates the peak (Step S34). Specifically, the evaluation value and the lens position stored in the evaluation value storage section 44 are subjected to approximation to quadric, and the lens position DFF_LF which serves as the peak of the curve is calculated. Then, the DFF control parameter calculation section 42 provides the calculated lens position DFF_LF to the optical system control section 24, and drives the focus lens of the optical system 12 to the position (Step S36). Thereby, focus detection is finished (Step S38).

As described above, according to the second embodiment, the noted subject is extracted by DFD, and the hill climbing method is performed only for a block corresponding to the result of DFD. Thereby, the peak of the evaluation value can be calculated without being influenced by the evaluation value calculated from luminance information of the region other than the noted subject. Consequently, the in-focus accuracy can be improved.

Further, since the hill climbing method is performed for part of blocks, not for the whole luminance information, the effect of reducing the operation cost is obtained.

### First Modification of the Second Embodiment

Although the second embodiment shows the case where the focus detection apparatus is applied to the compact camera 10, it goes without saying that the focus detection apparatus is also applicable to single-lens reflex cameras as in the modification of the first embodiment, and an equivalent effect is obtained.

### Second Modification of the Second Embodiment

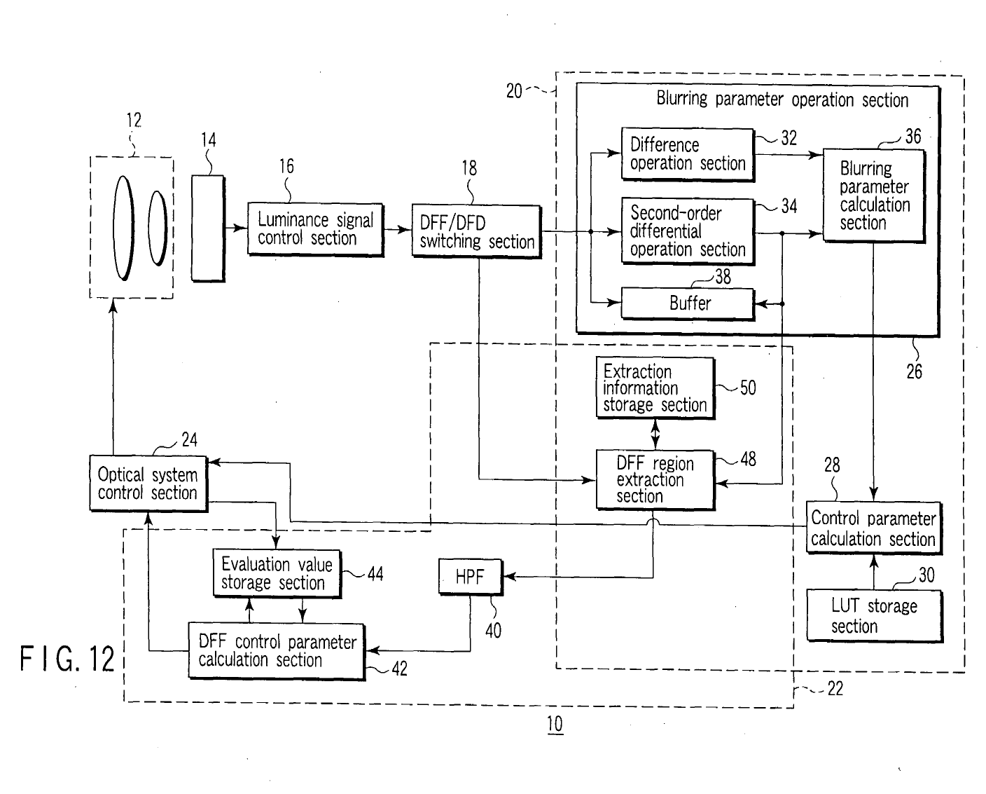

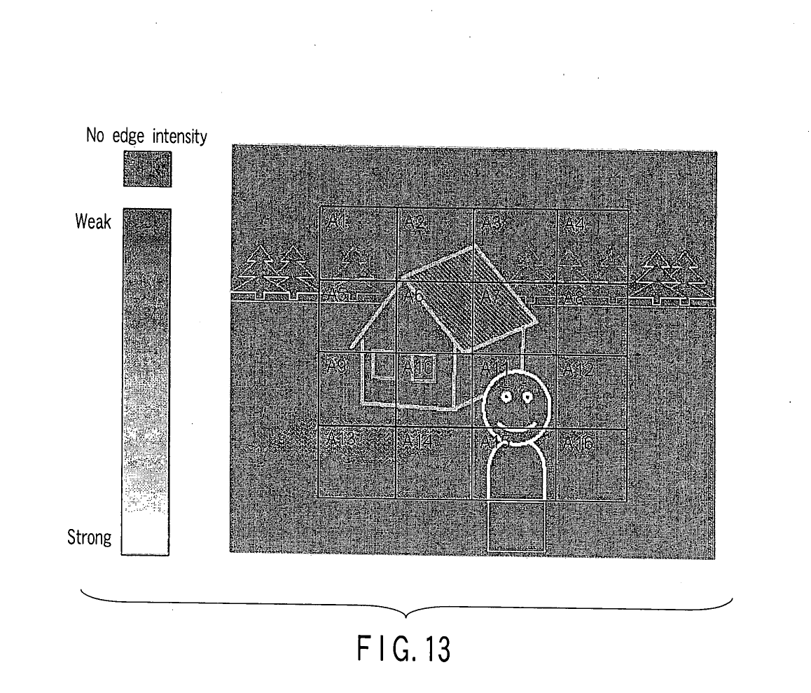

Further, although the second embodiment is explained with the case where extraction of the region is performed by using the distance information obtained as a result of DFD, extraction of the region may be performed by using a result of second-order differential determined in the process of calculating the blurring parameter as illustrated in FIG. 13, by providing the operation result of the second-order differential operation section 34 to the DFF region extraction section 48 as illustrated in FIG. 12.

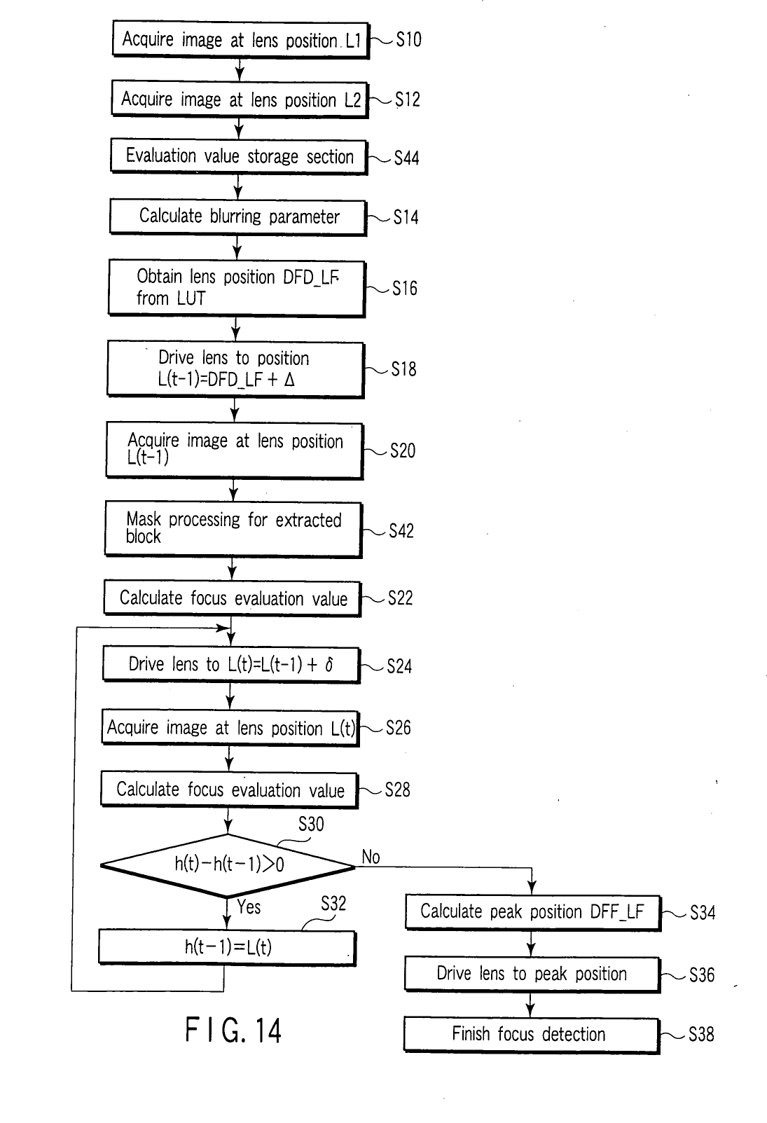

The processing in this case is explained in detail with reference to the flowchart of FIG. 14. Also in this modification, luminance information of the first image of the subject is acquired at the first lens position L1 (Step S10), and luminance information of the second image of the subject is acquired at the second lens position L2 (Step S12).

In the blurring parameter operation section 26, the second-order differential operation section 34 determines second-order differentials of the two images acquired at the different focus-lens positions, and calculates the mean value of the second-order differentials. The mean value of the second-order differentials is supplied to the DFF region extraction section 48 as differential information. The DFF region extraction section 48 extracts a block in which the mean value of the second-order differentials of the two images exceeds a threshold value, as a region for which the blurring parameter is calculated, and stores the position information of the block (A11 and A15 in the example of FIG. 13) in the extraction information storage section 50 (Step S44).

Further, the blurring parameter operation section 26 calculates the blurring parameter by division of the difference between the two images acquired at the different focus lens positions by the mean value of the second-order differentials of the two images (Step S14). Then, the control parameter calculation section 28 determines the in-focus lens position for the subject by linear interpolation, by using the calculated blurring parameter and the information of the LUT stored in the LUT storage section 30. The in-focus lens position is calculated pixel by pixel for the edge portion of the image of the subject formed on the image plane, and the position which has the shortest distance as the in-focus lens position DFD_LF of the subject (Step S16).

An estimated error Δ of the in-focus lens position DFD_LF obtained in this step is larger than the tolerance, since the in-focus lens position for the subject minutely varies due to lens barrel mounting error of individual cameras. Therefore, a position which is distant from the estimated in-focus lens position by the estimated error Δ beyond the lens barrel mounting error is set as the target lens position DFD_LF+Δ, and inputs it to the optical system control section 24. Then, the focus lens is driven (Step S18).

Next, the hill climbing method is performed for the extracted block. The following processing is the same as that described in the second embodiment, and explanation thereof is omitted.

As described above, according to the second modification, the edge portion of the subject is extracted by the second-order differential, it is possible to extract the subject region existing on the image plane. The block having the highest edge intensity is extracted by the DFF region extraction section 48, and the hill climbing method is performed by using only the luminance information of the extracted block. Thereby, the effect equal to the effect obtained by the second embodiment can be obtained.

Although extraction of the region is performed based on the intensity of the edge, a main subject may be extracted on the basis of the structure of the edge.

Further, calculation of the blurring parameter by the parameter calculation section 36 in Step S14 may be performed only for the block extracted by the DFF region extraction section 48.

The second modification can also be applied to single-lens reflex cameras as a matter of course.

### Third Modification of the Second Embodiment

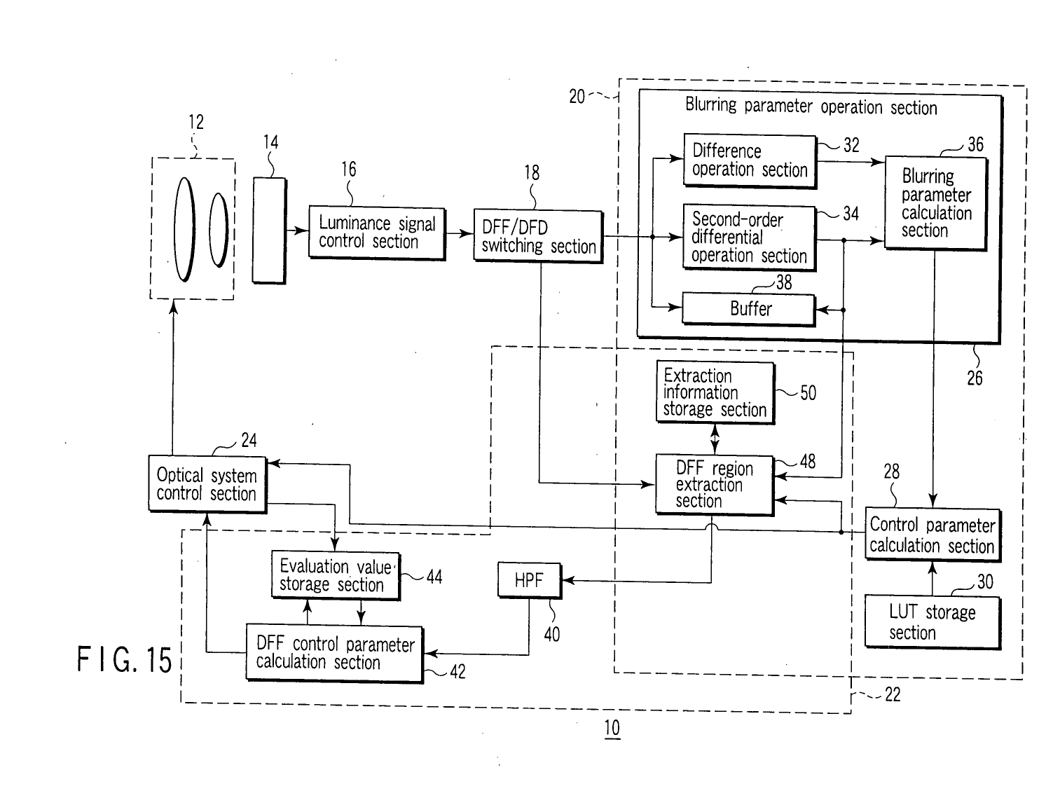

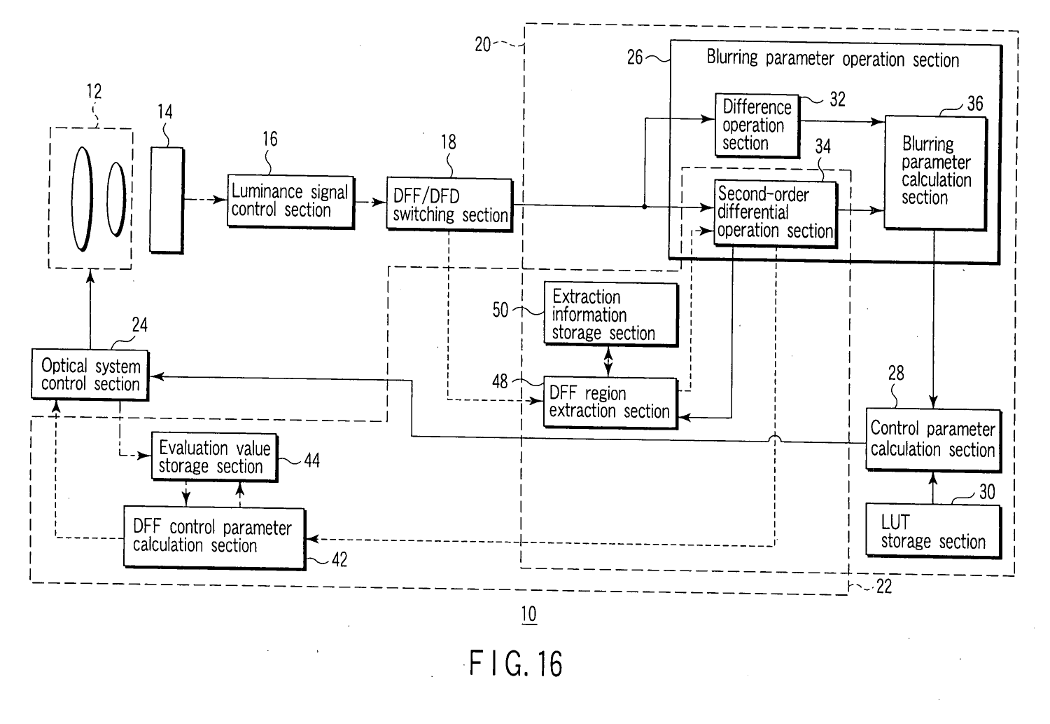

As illustrated in FIG. 15, the equivalent effect can be obtained by performing extraction of the region by providing the operation result (FIG. 13) of the second-order differential operation section 34 and the distance information (FIG. 9) from the control parameter calculation section 28 to the DFF region extraction section 48.

Also in the third modification, the subject region can be extracted based on a result of the second-order differentials, as explained in the second modification. Further, erroneous extraction of the subject can be further prevented by using the distance information obtained from DFD, in comparison with the case of using only the result of second-order differentials.

The third modification is also applicable to single-lens reflex cameras as a matter of course.

### Third Embodiment

A focus detection apparatus according to the third embodiment has a structure as illustrated in FIG. 16. In FIG. 16, arrows of solid lines indicate flows of signals and information to perform the DFD method, and arrows of broken lines indicate flows of signals and information to perform the hill climbing method. Further, arrows of alternate long and short dashed lines indicate flows of signals and information common to the DFD method and the hill climbing method.

In the third embodiment, as indicated by the solid lines, the output of the second-order differential operation section 34 is used first for distance estimation in the distance estimating section 20, and for region extraction in the DFF region extraction section 48 as in the third modification of the second embodiment. Then, after the distance estimation, as indicated by the broken lines, the second-order differential operation section 34 subjects a luminance signal of a block extracted by the DFF region extraction section 48 to second-order differential, and supplies the result to the DFF control parameter calculation section 42 of the hill climbing method operation section 22.

As described above, the third embodiment has a structure in which the second-order differential operation section 34 of the blurring parameter operation section 26 is shared with and also used in the hill climbing operation section 22. Specifically, the second-order differential operation section 34 of the blurring parameter operation section 26 has an HPF characteristic which lets high-frequency components pass. Therefore, when the hill climbing method is performed, it is unnecessary for the hill climbing operation section 22 as described in the first or second embodiment to have an HPF, by using the second-order differential operation section 34 of the blurring parameter operation section 26.

According to the third embodiment having the above structure, it is unnecessary to provide an HPF to the hill climbing operation section 22, and thus the size of the circuit can be reduced.

### Modification of the Third Embodiment

Although the third embodiment shows the case where the focus detection apparatus is applied to the compact camera 10, it goes without saying that the focus detection apparatus is also applicable to single-lens reflex cameras as in the modification of the first embodiment, and an equivalent effect is obtained.

### Fourth Embodiment

The first to third embodiments are explained with the structure in which the position of the optical system 12 is changed by driving the position of the focus lens and the aperture, two luminance information items having different blurring degrees are obtained, and an in-focus image is obtained by adjusting the position of the focus lens.

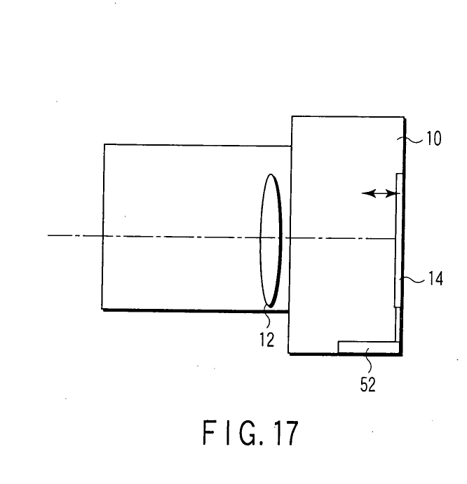

In the fourth embodiment, as illustrated in FIG. 17, there is provided an image acquisition device control section 52, which functions as a position control section for changing the position of the luminance information acquiring section by driving the image acquisition device 14 in the optical axis direction. Further, luminance information items having different blurring degrees are obtained by driving the image acquisition device 14 in the optical axis direction, instead of adjusting the position of the focus lens. In this case, the LUT storage section 30 should store relationship between the blurring parameter and the position of the image acquisition device 14, as relationship between the blurring parameter and the in-focus position of light from the subject.

This structure can also obtain the same effect as those of the first to third embodiments.

### Fifth Embodiment

The above operation sections and the calculation sections may be formed of one hardware such as DSP and CPU.

The present invention explained above based on the embodiments is not limited to the above embodiments, but can be variously modified and applied as a matter of course within the range of the gist of the invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A focus detection apparatus which determines a focal position by using light beam that is passed an optical system which forms an image of light from a subject in a predetermined position, comprising:
a luminance information acquiring section configured to acquire luminance information of the image formed by the optical system;
a blurring parameter operating section configured to calculate a blurring parameter corresponding to a distance from the optical system to the subject, based on two luminance information items which have different blurring degrees and are acquired by the luminance information acquiring section;
a distance estimating section configured to estimate distance information corresponding to the distance from the optical system to the subject, based on the blurring parameter calculated by using the blurring parameter operating section; and
a focus detection section configured to acquire luminance information by using the luminance information acquiring section after changing arrangement setting of one of the optical system and the luminance information acquiring section based on the distance information estimated by the distance estimating section, to acquire luminance information items having different blurring degrees by the luminance information acquiring section by further changing arrangement setting of the one of the optical system and the luminance information acquiring section, to calculate an evaluation value indicating a degree of focus from each of the luminance information items having the different blurring degrees, and to determine the focal position based on the evaluation value.

2. A focus detection apparatus according to claim 1, further comprising:
an arrangement control section configured to arrange the one of the optical system and the luminance information acquiring section, based on the distance information estimated by the distance estimating section,
wherein a position of the one of the optical system and the luminance information acquiring section arranged by the arrangement control section is a position which is distant, in a direction of a focus at one of an infinite distance and a near point and in an optical axis direction with a predetermined distance, from a position of the one of the optical system and the luminance information acquiring section in which focus is attained for the distance of the subject.

3. A focus detection apparatus according to claim 2, wherein the position of the one of the optical system and the luminance information acquiring section is located between a lens position, in which a last acquired image is obtained by the distance estimating section, and the focal position.

4. A focus detection apparatus according to claim 2, wherein the predetermined distance is larger than a tolerance of assembly of a focus adjusting optical system.

5. A focus detection apparatus according to claim 1, further comprising:
an information transmission/reception section configured to transmit and receive information between the distance estimating section and the focus detection section,
wherein the distance estimating section and the focus detection section transmit and receive information each other through the information transmission/reception section.

6. A focus detection apparatus according to claim 5, wherein the information includes the distance information obtained by the distance estimating section.

7. A focus detection apparatus according to claim 5, wherein the blurring parameter operating section includes a differential information operating section configured to calculate differential information of the luminance information acquired by the luminance information acquiring section, and
the information includes the differential information.

8. A focus detection apparatus according to claim 5, wherein the information transmission/reception section includes:
a region extracting section configured to extract a region on an image plane based on information obtained by one of the distance estimating section and an operating section forming the distance estimating section, the region serving as a subject of calculation of an evaluation value in the focus detection section; and
an extraction information storing section configured to store a position of the region on the image plane extracted by the region extracting section.

9. A focus detection apparatus according to claim 8, wherein the region extracting section performs region extraction based on the distance information obtained by the distance estimating section.

10. A focus detection apparatus according to claim 8, wherein the blurring parameter operating section includes a differential operating section configured to calculate differential information of the luminance information acquired by the luminance information acquiring section, and
the region extracting section performs region extraction based on the differential information obtained by the differential operating section.

11. A focus-detection apparatus according to claim 8, wherein the blurring parameter operating section includes a differential operating section configured to calculate differential information of the luminance information acquired by the luminance information acquiring section, and
the region extracting section performs region extraction based on the distance information obtained by the distance estimating section and the differential information obtained by the differential operating section.

12. A focus detection apparatus according to claim 1, wherein the blurring parameter operating section includes a differential operating section configured to calculate second-order differential information of the luminance information acquired by the luminance information acquiring section, and
the focus detection section uses the differential operating section in the blurring parameter operating section, when the focus detection section calculates the evaluation value.
